(19) United States
(12) Patent Application Publication
(10) Pub. No.: US 2011/0102591 A1
(43) Pub. Date: May 5, 2011

(54) MOBILE PHONE HAVING A BLACK BOX FEATURE FOR A VEHICLE AND METHOD OF PHOTOGRAPHING AN IMAGE

(75) Inventors: Young-Kwon YOON, Seoul (KR); Sung-Wook Choi, Suwon-si (KR)

(73) Assignee: Samsung Electronics Co., Ltd., Suwon-si (KR)

(21) Appl. No.: 12/904,505

(22) Filed: Oct. 14, 2010

(30) Foreign Application Priority Data
Nov. 5, 2009 (KR) 10-2009-0106414

(51) Int. Cl. H04N 7/18; H04N 5/228

(52) U.S. Cl. 348/148; 348/222.1; 348/E07.085; 348/E05.031

(57) ABSTRACT

A portable terminal having a black box feature for a vehicle is provided, which includes a camera unit having an image sensor for sensing incident light and a lens unit; a storage unit for storing an image photographed by the camera unit; and a control unit for selecting a first region of the image sensor when a black box mode is selected, while selecting a second region that is a part of the first region of the image sensor when a general image mode is selected, controlling the camera unit to photograph an image that is formed on the selected region, and providing the photographed image to the storage unit. An image without distortion can be photographed in the case of photographing a general image, while a wide range outside of a vehicle can be photographed in the case of photographing a black box image.

### PRIORITY

This application claims priority under 35 U.S.C. §119(a) to an application entitled “Mobile Phone Having Black Box Feature For Vehicle And Method Of Photographing Image” filed in the Korean Industrial Property Office on Nov. 5, 2009 and assigned Serial No. 10-2009-0106414, the contents of which are hereby incorporated by reference.

### BACKGROUND OF THE INVENTION

1. Field of the Invention

The present invention generally relates to a portable terminal, and more particularly to a portable terminal having a black box feature for a vehicle.

2. Description of the Related Art

In general, a black box is a device that records a traveling condition of a vehicle, video and audio outside the vehicle, voices inside the vehicle, and the like. When a traffic accident occurs, objective evidence, such as surrounding circumstances of the accident, speed information, and the like, may be insufficient, and in this case, it may be difficult to closely examine the cause of accident and a fault of the person concerned. Accordingly, if a traffic accident occurs, a black box is very useful to secure the objective evidence.

Recently, black boxes released for vehicles have become much more miniaturized, and integrated products which provide accurate position information and speed information of vehicles using GPS (Global Positioning System) and electric maps have been placed on the market. Also, a multichannel black box which can photograph the outside of a vehicle in all directions with cameras installed in front and in the rear of the vehicle, and further on left and right sides of the vehicle during vehicle operation has been placed on the market.

However, since conventional black boxes are not provided with a separate display, there is a problem that the accident situation cannot be directly confirmed at the accident location after the accident situation is recorded in the black box. Also, a black box with a display, which has been released to solve the above-described problem, is expensive due to the increase of the manufacturing cost, and thus this may cause a heavy burden in expense to a consumer. Even in the case of purchasing a black box without a display, there still exists a burden regarding the expense in that a separate device, the black box, must be purchased and installed in the original vehicle.

On the other hand, a camera installed inside a conventional black box typically has a viewing angle of 90 to 160 degrees and supports a resolution in VGA class (640×480 pixels). That is, a camera installed inside a conventional black box uses a wide angle lens having a large viewing angle in order to photograph an image in a wider visual field outside of the vehicle. Since the wide angle lens has a wide viewing angle, it can substantially photograph an image in front of the lens. However, due to the structural characteristic of a camera that is manufactured using light refraction characteristics of a lens, corner portions of a photographed image are considerably distorted in comparison to the actual image, and thus an image photographed in a general image photography mode such as a portrait photography mode is not natural.

### SUMMARY OF THE INVENTION

Accordingly, the present invention has been made to solve the above-mentioned problems occurring in the prior art, and the present invention provides a portable terminal and a method of photographing an image using the portable terminal, which can avoid distortion of a photographed image by decreasing the viewing angle when a general image mode is selected and can photograph a wider range outside of a vehicle by increasing the viewing angle when a black box mode is selected. That is, the present invention provides a portable terminal and a method of photographing an image using the portable terminal, which can photograph a natural general image using a built-in digital camcorder and can effectively photograph a wide range outside of a vehicle using a black box feature.

In accordance with an aspect of the present invention, there is provided a portable terminal having a black box feature for a vehicle, which includes a camera unit having an image sensor for sensing incident light and a lens unit; a storage unit for storing an image photographed by the camera unit; and a control unit selecting a first region of the image sensor when a black box mode is selected, while selecting a second region that is a part of the first region of the image sensor when a general image mode is selected, controlling the camera unit to photograph an image that is formed in the selected region, and providing the photographed image to the storage unit.

In accordance with another aspect of the present invention, there is provided a method of photographing an image using a portable terminal, which includes selecting a photography mode through an input unit; determining whether the selected photography mode is a black box mode or a general image mode; if the black box mode is selected, selecting a first region of an image sensor, while if the general image mode is selected, selecting a second region that is a part of the first region of the image sensor; photographing an image that is formed on the selected region of the image sensor; and storing the photographed image.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating the configuration of a portable terminal having a black box feature for a vehicle according to an embodiment of the present invention;

FIG. 2 illustrates a camera unit according to an embodiment of the present invention;

FIG. 3 illustrates surface numbers of a camera unit according to an embodiment of the present invention;

FIG. 4 is a diagram illustrating a viewing angle;

FIG. 5 illustrates a first region and a second region of an image sensor according to an embodiment of the present invention;

FIG. 6 is a flowchart illustrating a process of photographing an image using a portable terminal according to an embodiment of the present invention;

FIG. 7 is a diagram illustrating a display screen for selecting a photography mode on a portable terminal;

FIG. 8 is a diagram illustrating a display screen for photographing an image in a general image mode; and

FIG. 9 is a diagram illustrating a display screen for photographing an image in a black box mode.

### DETAILED DESCRIPTION OF EMBODIMENTS OF THE PRESENT INVENTION

Hereinafter, embodiments of the present invention will be described with reference to the accompanying drawings. In the following description, a detailed description of known functions and configurations incorporated herein will be omitted when it may make the subject matter of the present invention rather unclear.

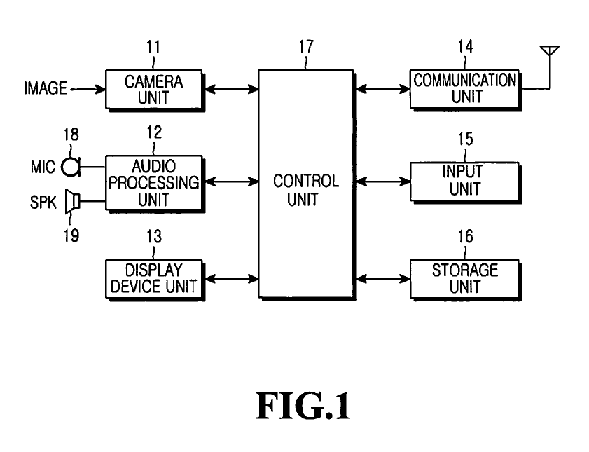

FIG. 1 is a block diagram illustrating the configuration of a portable terminal having a black box feature for a vehicle according to an embodiment of the present invention. As illustrated in FIG. 1, a portable terminal having a black box feature for a vehicle includes a camera unit 11, an audio processing unit 12, a display device unit 13, a communication unit 14, an input unit 15, a storage unit 16, and a control unit 17.

The camera unit 11 senses an object that is positioned in front of a lens, and converts an image of the object into image data.

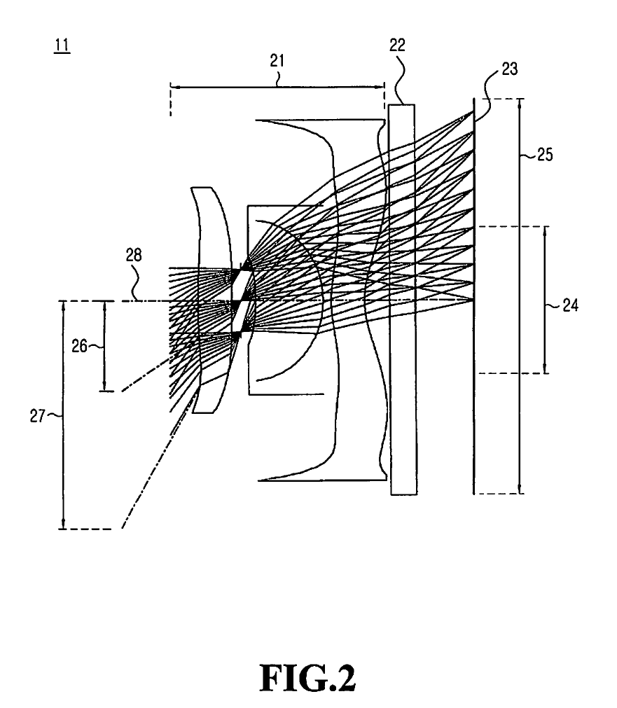

FIG. 2 illustrates a camera unit according to an embodiment of the present invention.

As illustrated in FIG. 2, a camera unit 11 included in a portable terminal includes a lens unit 21, an infrared blocking filter 22, and an image sensor 23.

The lens unit 21 includes a plurality of lenses. The plurality of lenses has rotational symmetry about an optical axis, and the optical axes of the plurality of lenses are arranged on one axis. The plurality of lenses may be in a spherical shape or non-spherical shape. In an embodiment of the present invention, as illustrated in FIG. 2, the lens unit 21 may be composed of three lenses formed of a plastic material. On the other hand, one of the important features that determine the characteristics of a lens is a focal length, which means a distance between the center of a lens, that is, a principal point, and a focal point at which an image is formed. As the focal point of a lens becomes longer, the diverging and converging operation of the lens is weakened. This phenomenon corresponds to the fact that the depth of field is low, and a lens having this characteristic is called a telephoto lens. Also, as the focal point of a lens becomes shorter, the diverging and converging operation of the lens is strengthened. This phenomenon corresponds to the fact that the depth of field is high, and a lens having this characteristic is called a wide-angle lens. The lenses included in the lens unit 21 are divided in accordance with the focal distance, that is, are divided into wide-angle lenses in the case where the focal distance is short and telephoto lenses in the case where the focal distance is long.

The infrared blocking filter 22 functions to block incident light in the infrared band to which the human eye does not sensitively react. The image sensor 23 sensitively reacts to incident light in the infrared band (having a wavelength of about 750 nm or more) which the human eye can hardly recognize. Accordingly, by the incident light in the infrared band, the image photographed by the image sensor 23 has a different color tone in comparison to a natural color, and thus the infrared blocking filter is used in a digital camera to block incident light in the infrared band.

The image sensor 23 has a structure in which pixels having the same configuration are arranged in the form of an N×M matrix. The image sensor 23 may be a CCD (Charge-Coupled Device) image sensor or a CMOS (Complementary Metal Oxide Semiconductor) image sensor.

Table 1 shows characteristic values of the camera unit 11 that includes three sheets of lens units 21, the infrared blocking filter 22, and the image sensor 23.

TABLE 1

| | | | Center |
|---|---|---|---|
| Surface | | Curvature | Thickness |
| Number | Surface Shape | (mm) | (mm) |
| 1 | Non-Spherical | 4.9 | 0.4 |
| | Surface | | |
| 2 | Non-Spherical | −24.7 | 0.106 |
| | Surface | | |
| Stop | Stop | Infinite | 0.177 |
| 4 | Non-Spherical | −1.56 | 0.815 |
| | Surface | | |
| 5 | Non-Spherical | −0.80 | 0.1 |
| | Surface | | |
| 6 | Non-Spherical | 0.97 | 0.4 |
| | Surface | | |
| 7 | Non-Spherical | 0.71 | 0.3 |
| | Surface | | |
| 8 | Spherical Surface | Infinite | 0.3 |
| 9 | Spherical Surface | Infinite | 0.7 |
| Image Sensor | Spherical Surface | Infinite | 0 |

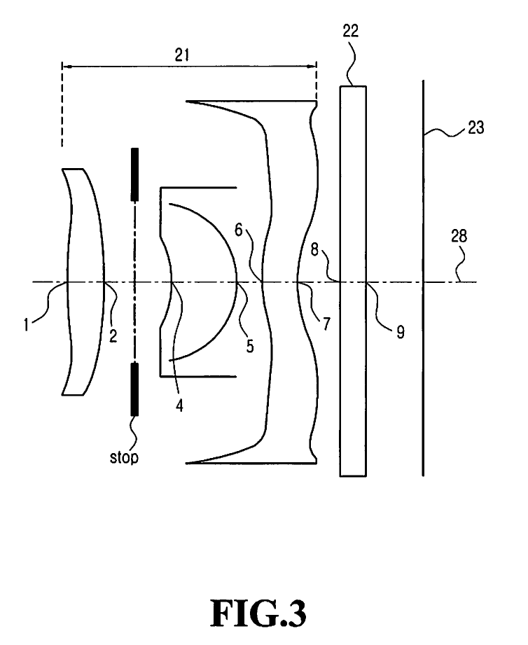

In Table 1, surface shapes, curvatures, and center thicknesses according to surface numbers are shown. The surface numbers are the numbers which designate surfaces where two different optical media come in contact with each other, that is, surfaces where air and a lens come in contact with each other, in order from the object side. FIG. 3 shows surfaces that correspond to the respective surface numbers in Table 1. The third surface number “Stop” indicates an iris which adjusts the quantity of light transferred to the image sensor through the lens unit 21. The tenth surface number “Image Sensor” indicates the surface of the image sensor 23.

The surface shapes indicate shapes of the surfaces that correspond to the respective surface numbers, and are divided into non-spherical types and spherical types. The curvatures indicate the curvatures of portions of the optical axis 28 of the surfaces that correspond to the respective surface numbers. The center thicknesses indicate the distances of the portions of the optical axis 28 from a surface corresponding to a surface number to a surface corresponding to the next surface number.

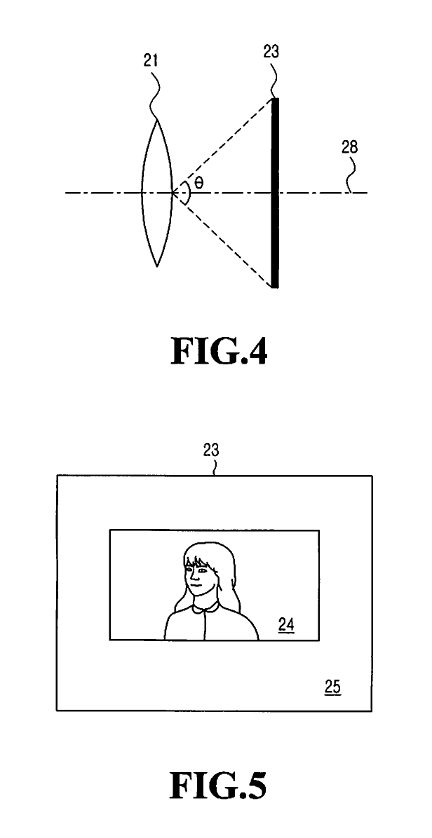

The image sensor 23 can support a resolution of VGA class (640×480 pixels) or more. On the other hand, the viewing angle means an angle between segments that connect a portion of the optical axis 28 of the last surface of the lens unit 21 to both ends of sensed regions of the image sensor 23, respectively. As illustrated in FIG. 4, the angle indicated by “θ” is the viewing angle. The kind of lens is determined by the viewing angle. In the case where two lenses have the same focal distance, the lens having a large viewing angle is called a wide-angle lens, and the lens having a small viewing angle is called a telephoto lens. In an embodiment of the present invention, the lens having a viewing angle of 70 degrees or more is considered as a wide-angle lens, and is applied to the camera unit 11.

In the case of photographing the same object in the same position, the wide-angle lens can photograph a wider range than that of the telephoto lens. Although the wide-angle lens having a large viewing angle can photograph a wide range, the depth of field is high, and thus there is a great difference in size between objects which have the same size but are positioned at a long distance and at a short distance, respectively. This phenomenon becomes more severe in corner portions of the photographed image, and thus the edge portions of the image photographed by the wide-angle lens become severely distorted.

Accordingly, in the case of applying a wide-angle lens to a portable terminal, it can be appropriately used in a black box mode in which a wider range outside of a vehicle is to be photographed. However, in the case of photographing a person, and particularly a face of a person, rather than photographing a wide range, it is not appropriate to photograph the face using the wide-angle lens since edge portions of the photographed image are distorted. By contrast, in the case of applying a telephoto lens to a portable terminal, a natural photograph without distortion can be obtained when photographing a person, but the viewing angle becomes small when photographing an object outside of a vehicle using a black box mode provided in the portable terminal to cause a limit in photographing the wide range outside of the vehicle.

According to the portable terminal having the black box feature according to an embodiment of the present invention, a wide-angle lens is used in the lens unit 21 to secure a sufficient viewing angle. As illustrated in FIG. 2, by securing the sufficient viewing angle using the wide-angle lens, a first region 25, which is the whole surface of the image sensor 23, is selected so that a wide range outside of the vehicle can be photographed in a black box mode. In the case of photographing a general image, a second region 24, which is a center portion of the whole surface of the image sensor 23 where distortion is small, is selected. Accordingly, both an image for a black box and a natural general image can be photographed.

FIG. 5 shows the first region 25 and the second region 24 of the image sensor 23. As illustrated in FIG. 5, in an embodiment of the present invention, the first region 25 and the second region 24 may be formed in tetragonal shapes, and the tetragons corresponding to the first region 25 and the second region 24 may be arranged to have a common center.

As illustrated in FIG. 2, the incident angle of light incident through a crop region 26 that is a partial region of the lens unit 21 when photographing a general image using the second region 24 of the image sensor 23 is smaller than the incident angle of light incident through a black box region 27 that is the whole region of the lens unit 21 when photographing a black box image using the first region 25 of the image sensor 23. Accordingly, in the case of photographing an object as a general image at the same place, only a narrow range of a scene spread in front of the lens unit 21 can be photographed in comparison to the case of photographing the object as a black box image.

With reference to FIG. 1, the audio processing unit 12 records audio generated inside or outside the traveling vehicle. The audio processing unit 12 includes a microphone (MIC) 18 and a speaker (SPK) 19. Accordingly, the sound generated inside or outside the vehicle can be recorded through the microphone 18, and the recorded sound can be reproduced through the speaker 19. The control unit 17 can perform synchronization of the audio data and the image data when reproducing the stored image and sound.

In an embodiment of the present invention, when the black box mode is selected, the sound inside or outside the vehicle is sensed, and the sensed sound is converted into digital audio data to be stored in the storage unit. By storing the audio data, evidence, which is very important in determining whether a driver has made a mistake or is at fault, such as whether a driver has sounded a horn, whether skidding during braking has occurred, whether a collision sound has occurred, or the like, can be secured when a traffic accident occurs.

The display device unit 13 displays an image of an object to be photographed or an image that is reproduced. The display device unit 13 may be an LCD (Liquid Crystal Display), an OLED (Organic Light Emitting Diodes), or the like. In the case of implementing the display device unit 13 as a touch screen type, the display device unit 13 can also operate as an input unit 15.

The communication unit 14 serves to transmit and receive audio data, text data, image data, and control data under the control of the control unit 17, and for this, it includes an RF transmitter for up-converting and amplifying the frequency of a transmitted signal, an RF receiver for low-noise-amplifying the received signal and down-converting the frequency of the received signal, and an antenna for signal transmission and reception. By using the communication unit 14, the image data photographed using a black box mode of the portable terminal can be stored in an external storage unit rather than the storage unit built in the portable terminal.

The input unit 15 has a key matrix structure (not illustrated) including character keys, numeral keys, various kinds of function keys, and an external volume key, and outputs a key input signal that corresponds to the key input by a user to the control unit 17. The input unit 15 may be integrated with the display device unit 13 by implementing a touch screen type display device unit 13.

The storage unit 16 stores image data photographed by the camera unit 11. Also, the storage unit stores general programs and applications for driving the portable terminal. Since image data corresponding to the latest time period among the photographed image data is stored and other data are deleted, the storage unit continues updating. The time period may be preset or set by a user. By doing this, the limited storage space of the storage unit can be effectively managed.

In an embodiment of the present invention, the portable terminal may further include an accident sensing unit. The accident sensing unit has a built-in acceleration sensor or rotation sensing sensor, and senses impact when a traffic accident occurs. The image data photographed and stored for a predetermined time period before and after the time when the impact is sensed may be continuously stored without deletion, and this predetermined time may be preset or set by a user. Accordingly, the image data photographed and stored for the time period before and after the occurrence of the traffic accident is prevented from being automatically deleted from the storage unit.

The control unit 17, when a user selects a black box mode, controls the camera unit 11 to sense an image formed on the first region 25 of the image sensor 23 of the camera unit 11 and to convert the sensed image into image data. If the user selects a general image mode, the control unit 17 controls the camera unit 11 to sense only an image formed on the second region 24 that is inside the first region 25 of the image sensor 23.

The control unit can compress the photographed image signal to reduce the capacity of the photographed image data. The image photographed and converted into image data through the camera unit 11 is in a form in which several frames that constitute the image gather together on a time axis. That is, images may be considered as photographs obtained by continuous photographing for a given time. Since such images require a large amount of storage unless they are compressed, it is quite inefficient to store the photographed images in the storage unit without compression, and thus it is necessary to compress the images. In compressing a moving image, a method using correlations between frames, spatial correlations, and the characteristic of viewing angle that is sensitive to a low-frequency component may be used. Since the original data may be lost due to the compression, the image photographed by selecting a black box mode should be compressed at an appropriate compression rate as high as can be identified.

The portable terminal having a black box feature for a vehicle according to an embodiment of the present invention can make it possible to avoid distortion of the image by decreasing the viewing angle when a general image mode is selected, while it can make it possible to photograph a wider range outside of the vehicle by increasing the viewing angle when a black box mode is selected. Accordingly, the portable terminal according to an embodiment of the present invention provides a natural general image photography mode and a black box image photography mode for a vehicle having a large viewing angle, in one portable terminal.

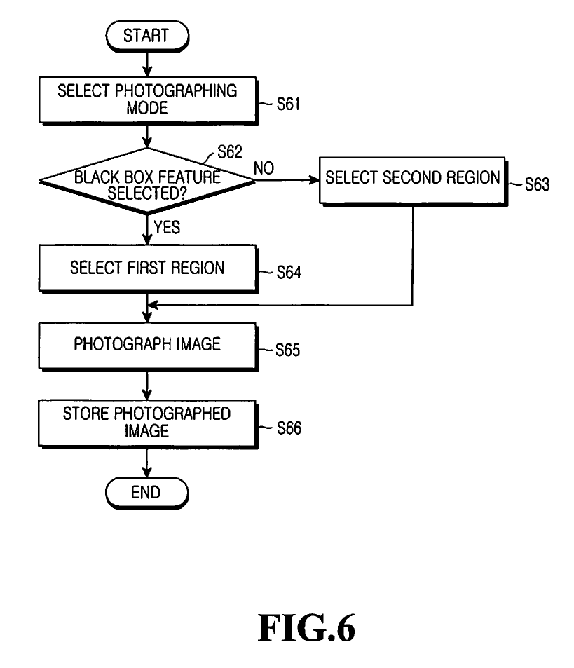

FIG. 6 is a flowchart illustrating a process of photographing an image using a portable terminal according to an embodiment of the present invention.

As illustrated in FIG. 6, a method of implementing a black box for a vehicle using a portable terminal includes the steps of selecting a photography mode through an input unit in step S61, determining whether the selected photography mode is a black box mode or a general image mode in step S62, if the black box mode is selected, selecting a first region of an image sensor in step S64, while if the general image mode is selected, selecting a second region that is a part of the first region of the image sensor in step S63, photographing an image that is formed on the selected region of the image sensor in step S65, and storing the photographed image in step S66.

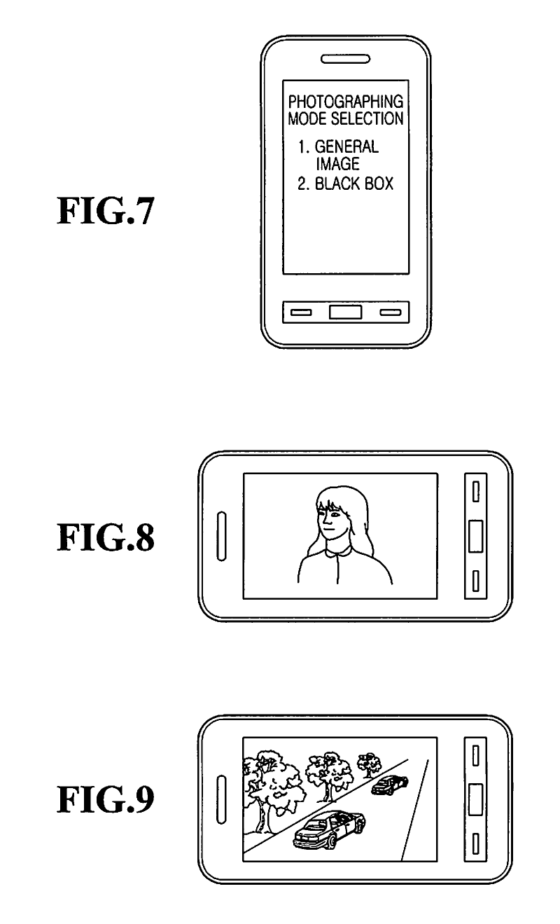

In step S61, selecting the photography mode, a user selects whether to photograph the image in a general image mode or in a black box mode through the input unit 15 provided in the portable terminal. As illustrated in FIG. 7, the user can confirm the photography mode selection menu through the display device unit 13 of the portable terminal, and can select the general image mode or the black box mode through the input unit 15. The user can use the portable terminal as a block box by combining the portable terminal with a bracket mounted on the vehicle. Also, the black box mode may be selected by manipulating a separate switch provided on the bracket or the black box mode may be automatically selected when the portable terminal is combined with the bracket.

In step S62, determining whether the selected photography mode is a black box mode or a general image mode, it is determined whether the photography mode selected by the user through the input unit 15 is the black box mode or the general image mode.

In steps S63 and S64, selecting the first region or the second region, if it is determined that the black box mode is selected, the first region that is the whole surface of the image sensor included in the portable terminal is selected (step S64), while if it is determined that the general image mode is selected, the second region that is within the first region of the image sensor included in the portable terminal is selected (step S63).

The image sensor of the portable terminal can support a resolution in VGA class (640×480 pixels) or more. On the other hand, the viewing angle means an angle between segments that connect a portion of the optical axis of the last surface of the lens unit of the portable terminal to both ends of sensed regions of the image sensor, respectively. As illustrated in FIG. 4, the angle indicated by “θ” is the viewing angle. The kind of the lens is determined by the viewing angle. In the case where two lenses have the same focal distance, the lens having a large viewing angle is called a wide-angle lens, and the lens having a small viewing angle is called a telephoto lens. In an embodiment of the present invention, the lens having a viewing angle of 70 degrees or more is considered as a wide-angle lens, and is used in the portable terminal.

In the case of photographing the same object in the same position, the wide-angle lens can photograph a wider range than that of the telephoto lens. Although the wide-angle lens having a large viewing angle can photograph a wide range, the depth of field is high, and thus there is a great difference in size between objects which have the same size but are positioned at a long distance and at a short distance, respectively. This phenomenon becomes more severe in corner portions of the photographed image, and thus the edge portions of the image photographed by the wide-angle lens are severely distorted.

Accordingly, in the case of applying a wide-angle lens to a portable terminal, it can be appropriately used in a black box mode in which a wider range outside of a vehicle is to be photographed. However, in the case of photographing a person, and particularly a face of a person, rather than photographing a wide range, it is not appropriate to photograph the face using the wide-angle lens since edge portions of the photographed image are distorted. By contrast, in the case of applying a telephoto lens to a portable terminal, a natural photograph without distortion can be obtained when photographing a person, but the viewing angle becomes small when photographing an object on the outside of a vehicle using a black box mode provided in the portable terminal to cause a limit in photographing the wide range outside of the vehicle.

According to an embodiment of the present invention to solve the above-described problems, a wide-angle lens is used in the lens unit 21 of the portable terminal to secure a sufficient viewing angle. By securing the sufficient viewing angle, the first region 25, which is the whole surface of the image sensor 23, is selected so that a wide range outside of the vehicle can be photographed when the black box mode is selected. When the general image mode is selected, the second region 24, which is the center portion of the whole surface of the image sensor 23 where distortion is small, is selected. Accordingly, both the image for the black box and the natural general image can be photographed.

FIG. 8 shows an image of an object displayed through the display device unit of the portable terminal when the general image mode is selected from the photography mode selection menu of the portable terminal. As shown in FIG. 8, in the case of photographing the general image such as an image of a person in which distortion should be avoided, an image having a small distortion can be photographed.

FIG. 9 shows an image outside of the vehicle displayed through the display device unit of the portable terminal when the black box mode is selected from the photography mode selection menu of the portable terminal. As shown in FIG. 9, if the black box mode is selected to photograph the wide range outside of the vehicle using the portable terminal as the black box, an image having a wide viewing angle can be photographed.

Referring back to FIG. 6, in step S65, photographing the image formed on the selected region of the image sensor, the image sensor of the portable terminal photographs the image formed on the first region 25 or the second region 24. Here, photographing the image means sensing the image formed on the image sensor and converting the sensed image into digital image data.

In step S66, storing the photographed image, the digital image data can be stored in a storage medium built in the portable terminal or the bracket or a storage medium detachably mounted on the portable terminal or the bracket. Also, the stored image data can be confirmed immediately through the display device built in the portable terminal.

The control unit of the portable terminal can compress the photographed image signal to reduce the capacity of the photographed image data. The image converted into image data is in the form in which several frames that constitute the image gather together on a time axis. That is, images may be considered as photographs obtained by continuous photographing for a given time. Since such images require a large amount of storage space unless they are compressed, it is quite inefficient to store the photographed images in the storage unit without compression, and thus it is necessary to compress the images. In compressing a moving image, a method using correlations between frames, spatial correlations, and the characteristic of viewing angle that is sensitive to a low-frequency component may be used. Since the original data may be lost due to the compression, the image photographed by selecting a black box mode should be compressed at an appropriate compression rate as high as can be identified.

Since the image corresponding to the latest time period among the photographed images is stored and other images before the predetermined time are deleted, the updating can continue. The time period may be preset or set by a user. By doing this, the limited storage space of the storage unit can be effectively managed.

In an embodiment of the present invention, the portable terminal may further include an accident sensing unit, and the step of continuously storing the corresponding image without deletion for a predetermined time before and after the accident occurs during traveling of the vehicle may be added. The accident sensing unit has a built-in acceleration sensor or rotation sensing sensor, and senses impact when a traffic accident occurs. The image data photographed and stored for a predetermined time period before and after the time when the impact is sensed may be continuously stored without deletion, and this predetermined time may be preset or set by a user. Accordingly, the image data photographed and stored for the time period before and after the occurrence of the traffic accident is prevented from being automatically deleted from the storage unit after the predetermined time elapses.

The method of implementing the black box for the vehicle using the portable terminal according to an embodiment of the present invention can make it possible to avoid distortion of the image by decreasing the viewing angle when a general image mode is selected, while it can make it possible to photograph a wider range outside of the vehicle by increasing the viewing angle when a black box mode is selected. Accordingly, in an embodiment of the present invention, a natural general image photography mode and a black box image photography mode for a vehicle having a large viewing angle can be provided using a single portable terminal.

While the present invention has been shown and described with reference to certain exemplary embodiments thereof, it will be understood by those skilled in the art that various changes in form and details may be made therein without departing from the spirit and scope of the present invention as defined by the appended claims.

What is claimed is:

1. A portable terminal having a black box feature for a vehicle, comprising:
a camera unit having an image sensor for sensing incident light and a lens unit;
a storage unit storing an image photographed by the camera unit; and
a control unit selecting a first region of the image sensor when a black box mode is selected, while selecting a second region that is a part of the first region of the image sensor when a general image mode is selected, controlling the camera unit to photograph an image that is formed on the selected region, and providing the photographed image to the storage unit.

2. The portable terminal as claimed in claim 1, wherein the lens unit has a wide-angle lens having a viewing angle of 70 degrees or more.

3. The portable terminal as claimed in claim 1, wherein the first region and the second region are formed in tetragonal shapes on the image sensor, and have a common center.

4. A method of photographing an image using a portable terminal, comprising the steps of
selecting a photography mode through an input unit;
determining whether the selected photography mode is a black box mode or a general image mode;
if the black box mode is selected, selecting a first region of an image sensor, while if the general image mode is selected, selecting a second region that is a part of the first region of the image sensor;
photographing an image that is formed on the selected region of the image sensor; and
storing the photographed image.

5. The method as claimed in claim 4, wherein in the step of photographing the image, the image is photographed using a wide-angle lens having a viewing angle of 70 degrees or more.

6. The method as claimed in claim 4, wherein in the step of photographing the image, the first region and the second region are formed in tetragonal shapes on the image sensor, and have a common center.
